(19) United States
(12) Patent Application Publication
(10) Pub. No.: US 2017/0309196 A1
(43) Pub. Date: Oct. 26, 2017

(54) USER ENERGY-LEVEL ANOMALY DETECTION

(71) Applicant: MICROSOFT TECHNOLOGY LICENSING, LLC, Redmond, WA (US)

(72) Inventors: VIPINDEEP VANGALA, HYDERABAD (IN); KURUMADDALI VENKATA MADHU SRAVANTH, HYDERABAD (IN)

(21) Appl. No.: 15/182,152

(22) Filed: Jun. 14, 2016

(30) Foreign Application Priority Data
Apr. 21, 2016 (IN) 201641013912

(51) Int. Cl. G09B 5/12; G09B 19/00

(52) U.S. Cl. CPC G09B 5/125; G09B 19/00

(57) ABSTRACT

Aspects of the technology described herein can analyze user data from multiple computing devices to ascertain a user's energy level and detect anomalies. When an anomaly is detected, the technology described herein can make suggestions to increase the user's energy level. The suggestions can be generated by analyzing user data from the crowd to determine what worked for similarly situated users.

### CROSS REFERENCE TO RELATED APPLICATIONS

This application claims priority to Indian Patent Application having Application No. 201641013912. filed in India on Apr. 21, 2016, entitled “USER ENERGY-LEVEL ANOMALY DETECTION,” the entirety of which is hereby incorporated by reference.

### BACKGROUND

A person's energy level can impact his productivity and enjoyment of life. People can often make poor activity choices that can result in diminished energy levels. Often small choices made over time can result in diminished energy. A person may realize he is tired, but not realize what changed or the best way to make a positive change. Also there is an inherent mapping from the user behavior to the anomalies in digital systems he uses. Identifying these anomalies (behavior and data) is important for providing a framework of life improvements and task completion.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the technology described herein improve a computing device's ability to accurately extract contextual features related to a user's energy level from user data. Aspects of the technology described herein can analyze user data from multiple computing devices to ascertain a user's energy level and detect anomalies. When an anomaly is detected, the technology described herein can make suggestions to increase the user's energy level. The suggestions can be generated by analyzing user data from the crowd to determine what worked for similarly situated users.

Aspects of the technology described herein can determine anomalies in a user's energy level and energy-related behaviors and suggest remedies to restore the user's energy level to a baseline energy level for the particular user. The remedies can be specific actions the user can take, such as getting more sleep, spending more time with family, spending less time at work, a specific exercise routine, and such. The user's energy level can be determined using a combination of direct physiological measurements and detection of events that can provide information about a user's energy level.

Exemplary computing devices that can provide user data related to a user's energy level can include a mobile computing device (e.g., smartphone) that captures location signals and other contextual data and a wearable computing device (e.g., fitness tracker) that captures physiological characteristics of the user, such as heart rate, temperature, and movement. The signals can also include browsing history, device usage of any kind, search history, entertainment experiences, etc. The signals captured by the multiple computing devices can be analyzed together to determine when an individual is experiencing an anomalous energy level.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example computing architecture suitable for implementing aspects of the present disclosure;

FIGS. 3-5 are flow diagrams showing additional exemplary methods of inferring an energy level, in accordance with an aspect of the technology described herein; and

FIG. 6 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In various aspects, systems, methods, and computer-readable storage media are provided to improve a computing device's ability to accurately extract contextual features related to a user's energy level from user data. Aspects of the technology described herein can analyze user data from multiple computing devices to ascertain a user's energy level and detect anomalies. When an anomaly is detected, the technology described herein can make suggestions to increase the user's energy level. The suggestions can be generated by analyzing user data from the crowd to determine what worked for similarly situated users.

Aspects of the technology described herein can determine anomalies in a user's energy level and energy-related behaviors and suggest remedies to restore the user's energy level to a baseline energy level for the particular user. The remedies can be specific actions the user can take, such as getting more sleep, spending more time with family, spending less time at work, a specific exercise routine, and such. The user's energy level can be determined using a combination of direct physiological measurements and detection of events that can provide information about a user's energy level.

The direct physiological measurements can be taken from a computing device, such as a wearable fitness or health tracker. The direct physiological measurements can include heart rate, body temperature, blood sugar, blood pressure, and such.

The events related to energy level can be detected from a variety of signals received from computing devices, such as wearables, personal computers, smartphones, tablets, e-readers, augmented reality glasses, virtual reality glasses, and such. The relevant signals collected by these devices can include user browsing history, query data, GPS and other location data, travel times, application usage, phone records, messaging records, and similar. The various physiological and contextual signals can be combined to determine event data. Event data can include exercise events, sleep events, eating events, work events, transit events, phone conversation events, social events, entertainment events, browsing events, shopping events, and other events related to a user's energy level.

As used herein, energy level can be a composite measure of a user's daily productivity, as indicated by an ability to concentrate, accomplish tasks, and make positive health choices, and a user's mood or emotional state. In an aspect, the energy level is not a direct physiological measurement. The energy level can be measured on an arbitrary scale, such as between 1 and 10, 1 and 100, or similar. A baseline energy level can be calculated for each user. The baseline energy level can be calculated by averaging or otherwise combining periodic energy level calculations, such as daily energy level calculations. As enough user data is gathered, a user could be assigned a baseline energy level for different portions of a day or week. For example, a user could have a Monday baseline energy level, a Tuesday baseline energy level, and so forth.

Anomalies in a user's energy level can be detected by comparing a periodic energy level against a user's baseline energy level. The periodic energy level may be calculated and compared at a level of granularity that matches the user's baseline energy level. For example, if the user's baseline energy level is measured on a daily basis, then the periodic energy level in which an anomaly is found could also be a daily energy level.

Upon detecting an anomalous energy level in the user, a specific suggestion to elevate the user's energy level can be provided. In one aspect, crowd data is used to generate the suggestion. The crowd data can be mined to generate association rules between an anomalous energy level for users in a similar context and steps the other users took to escape from the anomalous energy level. For example, a user could fall out of an exercise routine. The crowd source data could indicate that starting even a relatively easy exercise event, such as a 20-minute walk, can be a positive first step to restoring the user's exercise routine and eventually the user's energy level.

In one aspect, a constituent of the user's energy level is the user's exercise routine. In order to calculate a user's exercise routine, a user's exercise events can be detected. The detection of a user's exercise event can be based on a combination of signals. For example, physiological signals, such as a user's elevated heart rate, could indicate that an exercise event is occurring. Location data associated with a gymnasium or other exercise facility could also confirm, either in isolation or in combination with other signals, that an exercise event likely occurred. In another aspect, calendar data indicating that an exercise event is to occur can be used to determine that an exercise event occurred, for example, in combination with a GPS data indicating a user's presence at a gym. In addition to detecting the exercise event, specific details about the exercise event, such as duration, type of exercise, intensity of exercise, and other factors, could be recorded. The combination of data can form an exercise event record that may be stored as part of a user record.

In one aspect, a sleep event is a constituent of the energy-level calculation. A sleep event can be calculated through a variety of different signal analyses. In one aspect, a wearable can detect physiological characteristics of the user that indicates sleep. In another aspect, the wearable has a program that makes a sleep determination and sends a record of the sleep determination to the technology described herein.

In another aspect, a sleep event can be inferred indirectly. For example, the user's interaction or lack of interaction with a computing device, such as a television, mobile phone, or personal computer, can indicate a sleep event. For example, a user could check their mobile device shortly after waking up or watch television before falling asleep. If this is the case, the sleep event's origination and termination time could be determined by the user interacting or not interacting with her mobile device even apart from physiological data. A user cannot be both asleep and interacting with a mobile device, thus an interaction with a mobile device at any time, such as in the morning when a person would typically be waking up, can establish the termination of a sleep event. Similarly, the discontinuation of interactions with a computing device can indicate the initiation of a sleep event. In one instance, a user may watch television prior to sleeping, and turning off the television can approximate the initiation of a sleep event.

In one instance, a user can be directly quizzed periodically about their sleep habits to help train a classification system that can detect sleep events. For example, a user could be asked what time they typically go to sleep and wake up. User data could then be subsequently analyzed to confirm various sleep events.

In one aspect, eating events are used as a constituent of the energy-level calculation. Eating events can be detected using calendar data, location data, diary entries, calorie applications, and other signal sources. For example, a user's location at a restaurant could indicate an eating event. In another aspect, a user's purchases at a grocery store could be used to determine, over the course of a week, for example, the type of food that the user is eating. Some users explicitly track calories using a diet program, diary, calorie-counting application, or other application. Signals from these applications can be used to determine that an eating event occurred as well as the contents of the eating event. As mentioned, the duration of the eating event, the amount of food consumed, and the healthiness of the food consumed can be determined.

In one aspect, the healthiness of the food can be determined using a classification program that receives the type of food consumed as input and assigns a healthiness score. In one aspect, healthiness can be measured against a diet that the user has explicitly indicated an attempt to follow. For example, a high protein, high carbohydrate, or some other diet could be pursued by the user. In this case, the healthiness of the food could be compared against the parameters of the diet.

In one aspect, a work event can be a constituent of a user energy-level calculation. A user work event can be detected through a variety of signals, including GPS data indicating a user's location is at a place of work, computer usage data indicating that the user is performing work through their computing device, communication records indicating that the user is communicating with known work associates, and such.

In one aspect, the duration of a work event can be measured along with the quantity and quality of work performed. In one aspect, the quality of work performed can be measured by detecting thrashing behavior, pursuit of distractions, and other indications of poor work performance and concentration. For example, a user that opened a Word document and more or less continuously typed into that Word document for four hours could be assigned a high quality of work and a four hour quantity. On the other hand, a user that opened a document, typed intermittently while periodically checking the Internet, playing games, or pursuing other distractions for four hours could be assigned a poor quality of work and only one hour of work quantity (assuming one hour was spent on the document). In one aspect, a classifier is trained to detect work patterns and assign a work quality. The quantity of work could be measured by the amount of time actually performing work while in a work location.

In one aspect, transit or commute events can be a constituent of a user energy-level calculation. The transit event can be detected using user data, such as GPS data, that could indicate a length and velocity of movement. The transit event can be classified as a home-to-work commute or otherwise delineated by a start location and an end location. The time of day and duration of the transit event can also be recorded. In addition, the means of transportation (e.g., car, bus, train, bike) could be determined by analyzing a movement pattern.

In one aspect, a phone communication event can be a constituent of a user energy-level calculation. For example, users that are conversing with friends, family, and others may indicate a positive energy level. Users who are not communicating with others via phone or other communication mechanisms could indicate unhealthy behavior over time. A phone event can be captured by analyzing phone logs and other data on a user's phone.

In one aspect, a social event can be a constituent of a user energy-level calculation. A social event can comprise a gathering of friends and family for social interaction. A social event can be detected using calendar information indicating a social event, and GPS or other location data indicating a location consistent with a social event, such as a friend's house. A social event can also be detected by mining social network data for pictures, images, and posts, such as check-ins, communicating information about a particular social event, such as a birthday party, wedding, cookout, and such.

In one aspect, an entertainment event can be a constituent of a user energy-level calculation. An entertainment event can include a movie, sporting event, musical event, parade, etc. The user's presence at such an event can be determined through location data, mining social media posts, calendar data, purchase information, and similar.

In one aspect, a browsing event can be a constituent of a user energy-level calculation. A browsing event can comprise navigating to a webpage, dwell time on a webpage, user interactions on a webpage, and other information. A user can generate a variety of browsing events in sequence. For example, a user could visit a news page consisting of political articles and that would comprise a single browsing event. Next, a user could navigate to a sports page, which could comprise a second browsing event.

In one aspect, a shopping event can be a constituent of a user energy-level calculation. The shopping event can be determined through location data, credit card information, browsing history, query history, etc. The shopping event can indicate whether an item was purchased and a classification for the item. For example, an item could be classified as apparel, food, household item, etc.

Each identified event can be associated with contextual information directly related to the event, as well as peripheral contextual information describing other activities in a user's day that are not directly related to the event. The direct contextual information associated with an event can comprise a location where the event occurred, duration of the event, physiological characteristics associated with the event, the presence of other people during the event, and such. The direct contextual information can be learned through analysis of user data captured during the event. The peripheral contextual information can include a description of a user's activities during the day, days, and hours before or after an exercise event.

Aspects of the technology described herein can also use semantic data describing the user. Semantic information can include a user's social contacts, work contacts, interests, home location, work address, calendar data, tasks, and other information. The semantic data can be used to identify or define an event or energy-level pattern, and/or generate energy-level suggestions for the user.

Aspects of the technology can combine signals from multiple sources to eliminate false positives that occur when only one signal is used to determine whether an event occurred. For example, location or other contextual data could be used to cross check physiological data and physiological data can be used to cross-check location and other contextual data. In isolation, either of these signals can produce false positives (an event that would be classified as an exercise event, but that is not actually an exercise event). In this scenario, the physiological data indicating a possible exercise event is disambiguated using location data provided by the smartphone to conclude that an exercise event has not occurred. For example, cross-checking may cause an event to be classified as running to catch a bus instead of an exercise event. This can make a big difference in a user energy-level calculation. The exercise event can be positive, while running to catch the bus can suggest fatigue, overscheduling, or otherwise be an indicator of a lower energy level.

However, when the user data for multiple devices is consistent with a type of event, then an event description can be generated and stored in an event data store. The event description can include a context for the exercise event and a description of the exercise event. The context of the exercise event can include a location where the exercise event occurred, duration of the exercise event, and other people present during the event.

“Contextual signals,” as utilized herein, may reflect any attribute of a user (for instance, physical characteristics), the user's historical interaction with the system (e.g., behavior, habits, and system interaction patterns), and/or the user's recent interaction with the system (with “recency” being defined in accordance with a predetermined time frame relative to a given point in time) that may affect the likelihood or probability that the user desires to engage in a particular activity. Such contextual signals may include, by way of example only and not limitation, the location of the user of the computing device (determined utilizing, for instance, Global Positioning System (GPS) signals, Internet Protocol (IP) address, or the like), the time of day (either general (for instance, morning or afternoon) or exact (for instance, 6:00 pm)), the date (either exact or generally a particular month, season, etc.), a physical characteristic of the user (for instance, if the user is paralyzed and capable of only voice input, or the like), a task currently engaged in on the computing device by the user, a task recently engaged in on the computing device by the user (again with “recency” being defined in accordance with a predetermined time frame relative to a given point in time), an object the user is currently engaged with on the computing device (for instance, an entity such as a contact, a file, an image, or the like), an object the user was recently engaged with on the computing device, a function currently being performed by the user on the computing device, a function recently performed by the user on the computing device, hardware currently being utilized on the computing device, hardware recently utilized on the computing device, software currently being utilized on the computing device, and software recently utilized on the computing device.

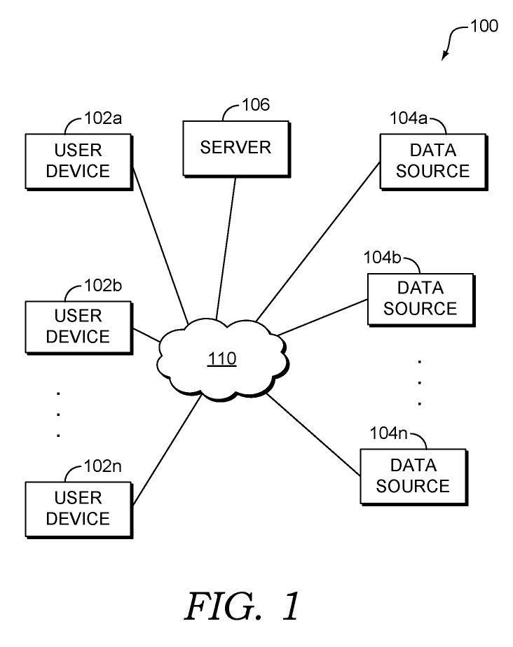

Having briefly described an overview of aspects of the technology described herein, an exemplary operating environment in which aspects of the technology described herein may be implemented is described below in order to provide a general context for various aspects. Referring to the figures in general and initially to FIG. 1 in particular, an exemplary operating environment for implementing technology described herein is shown and designated generally as exemplary operating environment 100. The exemplary operating environment 100 is but one example of a suitable computing environment and is not intended to suggest any limitation as to the scope of use or functionality of aspects of the technology described herein. Neither should the exemplary operating environment 100 be interpreted as having any dependency or requirement relating to any one component nor any combination of components illustrated.

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

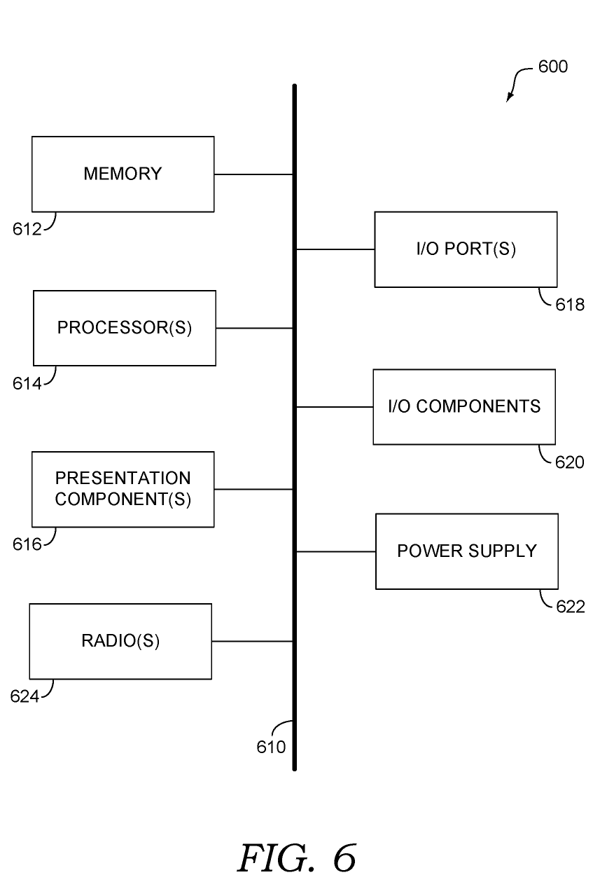

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 600 described in connection to FIG. 6, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can facilitate the completion of tasks and make a record of user activities. The user activities can be analyzed to determine a user's energy level. Server 106 can comprise server-side software designed to work in conjunction with client-side software on user devices 102a and 102b through 102n so as to implement any combination of the features and functionalities discussed in the present disclosure. For example, the server 106 may run an energy-level inference engine 260, which identifies an energy-level pattern for a user, and possibly energy-level anomalies. The server 106 may receive activity records, such as physiological data and location data, from the user devices. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 6 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

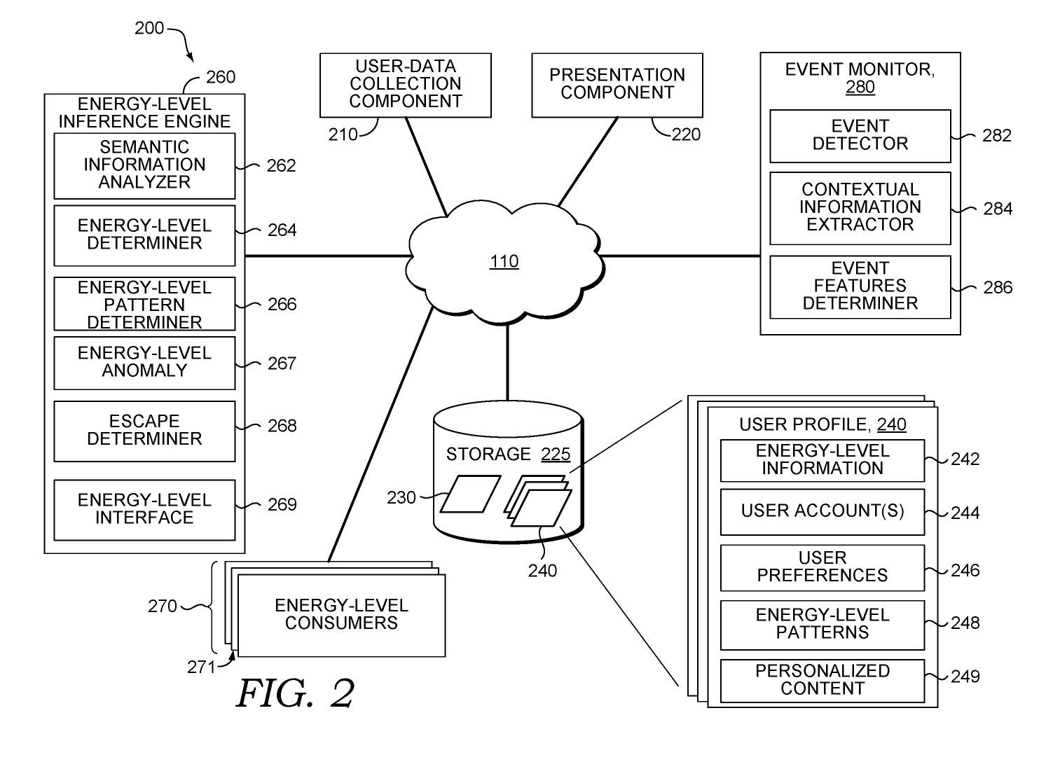

Data sources 104a and 104b through 104n may comprise data sources and/or data systems, which are configured to make data available to any of the various constituents of operating environment 100, or system 200 described in connection to FIG. 2. (For example, in one aspect, one or more data sources 104a through 104n provide (or make available for accessing) user data to user-data collection component 210 of FIG. 2.) Data sources 104a and 104b through 104n may be discrete from user devices 102a and 102b through 102n and server 106 or may be incorporated and/or integrated into at least one of those components. In one aspect, one or more of data sources 104a through 104n comprise one or more sensors, which may be integrated into or associated with one or more of the user device(s) 102a, 102b, or 102n or server 106. Examples of sensed user data made available by data sources 104a through 104n are described further in connection to user-data collection component 210 of FIG. 2. The data sources 104a through 104n can comprise a knowledge base that stores information about a venue, a user, or other entity related to a particular user action.

Operating environment 100 can be utilized to implement one or more of the components of system 200, described in FIG. 2, including components for collecting user data, identifying events associated with an energy level, inferring energy-level patterns and baselines, and detecting energy-level anomalies.

Referring now to FIG. 2, with FIG. 1, a block diagram is provided showing aspects of an example computing system architecture suitable for implementing an aspect and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including user-data collection component 210, presentation component 220, user event monitor 280, energy-level inference engine 260, energy-level consumers 270, and storage 225. User event monitor 280 (including its components 282, 284, and 286), energy-level inference engine 260 (including its components 262, 264, 266, 267, and 269), user-data collection component 210, presentation component 220, and energy-level consumers 270 may be embodied as a set of compiled computer instructions or functions, program modules, computer software services, or an arrangement of processes carried out on one or more computer systems, such as computing device 600 described in connection to FIG. 6, for example.

In one aspect, the functions performed by components of system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some aspects functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some aspects, user-data collection component 210 may be employed to facilitate the accumulation of user data of a particular user (or in some cases, a plurality of users including crowdsourced data) for user event monitor 280, energy-level inference engine 260, or an energy-level consumer 270. The data may be received (or accessed), and optionally accumulated, reformatted and/or combined, by user-data collection component 210 and stored in one or more data stores, such as storage 225, where it may be available to other components of system 200. For example, the user data may be stored in or associated with a user profile 240, as described herein. In some aspects, any personally identifying data (i.e., user data that specifically identifies particular users) is either not uploaded or otherwise provided from the one or more data sources with user data, is not permanently stored, and/or is not made available to user event monitor 280 and/or energy-level inference engine 260.

User data may be received from a variety of sources where the data may be available in a variety of formats. For example, in some aspects, user data received via user-data collection component 210 may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user-data associated with communication events; etc.) including, in some aspects, user activity that occurs over more than one user device, user history, session logs, application data, contacts data, calendar and schedule data, notification data, social-network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, global positioning system (GPS) data, vehicle user data, traffic data, weather data (including forecasts), wearable device data (which may include physiological data about the user such as heart rate, pulse oximeter or blood oxygen level, blood pressure, galvanic skin response, or other physiological data capable of being sensed or detected), other user device data (which may include device settings, profiles, network-related information (e.g., network name or ID, domain information, work group information, connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein.

In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some aspects, user-data collection component 210 receives or accesses data continuously, periodically, or as needed.

User event monitor 280 is generally responsible for monitoring user data for information that may be used for identifying and defining user energy-level events, which may include identifying and/or tracking features (sometimes referred to herein as “variables”) or other information regarding specific user actions and related contextual information. An energy-level event can be used as input to calculate an energy-level score. The event's occurrence and details are inferred from the user data. For example, physiological data consistent with sleep may be used to infer a sleep event. Using events, instead of actual data as input, can simplify the process of calculating a score by providing a more uniform input across users.

Aspects of user event monitor 280 may determine, from the monitored user data, when the user participates in an exercise event, sleep event, eating event, work event, social event, or other event relevant to energy level. In other words, the user event monitor 280 may receive user data and generate event data, such as a sleep event or social event. The event data can then be used to calculate an energy-level score of a user. As described previously, the user energy-level information determined by user event monitor 280 may include user energy-level information from multiple user devices associated with the user (e.g., a fitness tracker and mobile phone) and/or from cloud-based services associated with the user (such as email, calendars, social media, or similar information sources), and which may include contextual information associated with the identified user activities and events.

User event monitor 280 may identify current or near-real-time user event information and may also identify historical user event information, in some aspects, which may be determined based on gathering observations of user data over time, accessing user logs of past event data (such as a social event data store, a sleep event data store, or a work productivity data store).

Further, in some aspects, user event monitor 280 may identify user events (which may include historical events) from other similar users (i.e., crowdsourcing), as described previously. For example, physiological information from other users co-located with the user during a potential exercise event may be analyzed to determine the exercise event was a golf match. Alternatively, the physiological information from co-located users could be used to determine the intensity of an exercise event when physiological information about the user is not available during the event. For example, a user that is not associated with physiological data may be placed at a spin class through GPS and calendar information. Data from co-located individuals can be used to determine (with a certain confidence) that the spin class had a high intensity. Different variables associated with an event, such as an exercise event, can have different strengths or confidence. An intensity rating for an exercise event measured directly through the user's physiological data could have a higher confidence than an intensity rating derived indirectly, for example, from co-located user data.

In some aspects, information determined by user event monitor 280 may be provided to energy-level inference engine 260 including information regarding the current context and historical events (historical observations). Some aspects may also provide user energy-level information, such as probable upcoming exercise events, eating events, social events, or work events to one or more energy-level consumers 270.

As described previously, user energy-level event features may be determined by monitoring user data received from user-data collection component 210. In some aspects, the user data and/or information about the energy level determined from the user data is stored in a user profile, such as user profile 240.

As shown in example system 200, user event monitor 280 comprises a user event detector 282, contextual information extractor 284, and an event features determiner 286. In some aspects, user event monitor 280, one or more of its subcomponents, or other components of system 200, such as energy-level consumers 270 or energy-level inference engine 260, may determine interpretive data from received user data. Interpretive data corresponds to data utilized by these components of system 200 or subcomponents of user event monitor 280 to interpret user data. For example, interpretive data can be used to provide other context to user data, which can support determinations or inferences made by the components or subcomponents. Moreover, it is contemplated that aspects of user event monitor 280, its subcomponents, and other components of system 200 may use user data and/or user data in combination with interpretive data for carrying out the objectives of the subcomponents described herein. Additionally, although several examples of how user event monitor 280 and its subcomponents may identify user event information are described herein, many variations of event identification and user event monitoring are possible in various aspects.

User event detector 282, in general, is responsible for determining (or identifying) an energy-level-related event for the user by analyzing user data. Aspects of user event detector 282 may be used for determining a type of event occurred. Various heuristics can be used to determine that some events occurred. For example, a sleep heuristic could evaluate user data to identify when sleep started and stopped. Some aspects of user event detector 282 may monitor user data for energy-level-related features or variables corresponding to energy level in a user, such as indications of visits to exercise centric venues, physiological data, calendar data, and communications mentioning energy-level relevant information.

Additionally, some aspects of user event detector 282 extract from the user data information about user events relevant to energy level, which may include current user events, historical events, and/or related information such as contextual information. (Alternatively or in addition, in some aspects, contextual information extractor 284 determines and extracts contextual information that is related to one or more events. Similarly, in some aspects, event features determiner 286 extracts information about events based on an identification of the event determined by user event detector 282.) Examples of extracted event information may include physiological information, location information, movement information, weather data, etc., or nearly any other data related to events. Among other components of system 200, the extracted event information determined by user event detector 282 may be provided to other subcomponents of user event monitor 280, energy-level inference engine 260, or one or more energy-level consumers 270.

Further, the extracted event information may be stored in a user profile associated with the user, such as in energy-level information component 242 of user profile 240. In some aspects, user event detector 282 or user event monitor 280 (or its other subcomponents) performs conflation on the detected user information. For example, overlapping information may be merged and duplicated or redundant information eliminated.

In some aspects, the user energy-level-related features may be interpreted by a machine classification process to determine an energy-level-related event has occurred. For example, in some aspects, user event detector 282 employs user event logic, which may include rules, conditions, and/or associations, to identify or classify user events. The classifying of events (e.g., eating, sleep, work, social, exercise, transit) can be based on feature-matching or determining similarity in features, which falls under pattern recognition. This type of classification may use pattern recognition, fuzzy logic, neural network, finite state machine, support vector machine, logistic regression, clustering, or machine learning techniques, similar statistical classification processes, or combinations of these to identify events from user data. For example, exercise logic may specify types of physiological information that are associated with an exercise event, such as a user's heart rate staying a threshold amount above a baseline for a designated duration, in combination with location or movement data. Different patterns of activity may be mapped to different exercise events. For example, running, cycling, swimming, golf, tennis, and soccer may all have different activity patterns.

In some aspects, a user may specify features used for detecting an event or even a specific type of event. For example, upon detecting a possible social event, a personal assistant application may ask the user to confirm that she just watched a movie with friends A, B, and C, and may ask the user what movie was watched. Based on this feedback, activity patterns can be learned for the user and used to identify future social events. Similarly, event patterns from other users can be used to recognize events for a particular user.

In some aspects, user event detector 282 runs on or in association with each user device for a user. User event detector 282 may include functionality that polls or analyzes aspects of the user device to determine user event related features, such as sensor output, applications running (and in some instances the content of the applications), network communications, and/or other user actions detectable via the user device including sequences of actions.

Contextual information extractor 284, in general, is responsible for determining contextual information related to the events, such as context features or variables associated with an event, related information, and is further responsible for associating the determined contextual information with the detected event. In some aspects, contextual information extractor 284 may associate the determined contextual information with the related event and may also log the contextual information with the associated event. Some aspects of contextual information extractor 284 determine contextual information related to an event such as entities related to the event (e.g., other people present during the exercise event, work event, or social event) or the location or venue wherein the event took place. By way of example and not limitation, this may include context features such as location data, which may be represented as a location stamp associated with the exercise event; contextual information about the location, such as venue information (e.g., this is the user's office location, home location, gym, etc.) time, day, and/or date, which may be represented as a time stamp associated with the event; duration of the event, other user exercise/activities preceding and/or following the exercise, other information about the event such as entities associated with the event (e.g., venues, people, objects, etc.), information detected by sensor(s) on user devices associated with the user that is concurrent or substantially concurrent to the event (e.g., motion information or physiological information detected on a fitness tracking user device), or any other information related to the event that is detectable that may be used for determining patterns of user events and energy level. Other contextual information can include the amount of sleep a user received in the last week, average variance of fall-asleep and wake-up times, times the user ate last, what they ate, etc.—basically any contextual information that may be potentially usable to determine that a user's energy level varies from one situation to another based on the contextual information.

In aspects using contextual information related to user devices, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like. In some aspects, a device name or identification (device ID) may be determined for each device associated with a user. This information about the identified user devices associated with a user may be stored in a user profile associated with the user, such as in user account(s) 244 of user profile 240. In an aspect, the user devices may be polled, interrogated, or otherwise analyzed to determine contextual information about the devices. This information may be used for determining a label or identification of the device (e.g., a device ID) so that contextual information about an exercise event captured on one device may be recognized and distinguished from data captured by another user device. In some aspects, users may declare or register a user device, such as by logging into an account via the device, installing an application on the device, connecting to an online service that interrogates the device, or otherwise providing information about the device to an application or service. In some aspects, devices that sign into an account associated with the user, such as a Microsoft® account or Net Passport, email account, social network, or the like, are identified and determined to be associated with the user.

In some implementations, contextual information extractor 284 may receive user data from user-data collection component 210, parse the data, in some instances, and identify and extract context features or variables (which may also be carried out by event features determiner 286). Context variables may be stored as a related set of contextual information associated with the event, and may be stored in a user profile such as in user energy-level information component 242. In some cases, contextual information may be used by one or more energy-level consumers, such as for personalizing content or a user experience, such as when, where, or how to present suggestions for increasing energy level. Contextual information also may be determined from the user data of one or more users, in some aspects, which may be provided by user-data collection component 210 in lieu of or in addition to event information for the particular user.

Event features determiner 286 is generally responsible for determining energy-level-related features (or variables) associated with an event that may be used for identifying patterns of user energy levels. Energy-level features may be determined from information about an event and/or from related contextual information. In some aspects, event features determiner 286 receives information from user event monitor 280 (or its subcomponents), and analyzes the received information to determine a set of zero or more features associated with the energy-level event. Common features for different events can be used to help establish an energy-level pattern.

Examples of energy-level-related features include, without limitation, location-related features, such as location of the user device(s) during the event, venue-related information associated with the location, or other location-related information; time-related features, such as time(s) of day(s), day of week or month of the user event, or the duration of the event, or related duration information such as how long the user used an application; user device-related features, such as device type (e.g., desktop, tablet, mobile phone, fitness tracker, heart rate monitor, etc.), hardware properties or profiles, OS or firmware properties, device IDs or model numbers, network-related information (e.g., mac address, network name, IP address, domain, work group, information about other devices detected on the local network, router information, proxy or VPN information, other network connection information, etc.), position/motion/orientation-related information about the user device, power information such as battery level, time of connecting/disconnecting a charger, user-access/touch information; usage-related features, such as file(s) accessed, app usage (which may also include application data, in-app usage, concurrently running applications), network usage information, online activity (e.g., health and wellness related searches, browsed health and wellness websites, purchases, social networking related to exercise, communications sent or received including social media posts, user account(s) accessed or otherwise used (such as device account(s), OS level account(s), or online/cloud-services related account(s) activity, such as Microsoft® account or Net Passport, online storage account(s), email, calendar, or social networking accounts, etc.), features that may be detected concurrent with the energy-level event or near the time of the energy-level event, or any other features that may be detected or sensed and used for determining a pattern of user energy levels. Features may also include information about user(s) using the device; other information identifying a user, such as a login password, biometric data, which may be provided by a fitness tracker or biometric scanner; and/or characteristics of the user(s) who uses the device, which may be useful for distinguishing users on devices that are shared by more than one user.

Continuing with system 200 of FIG. 2, energy-level inference engine 260 is generally responsible for determining user energy levels and patterns based on the energy-level event information determined from user event monitor 280. The energy-level inference engine 260 can also detect anomalous energy levels and identify escape activities that can help the user return to a baseline energy level. In some aspects, energy-level inference engine 260 may run on a server, as a distributed application across multiple devices, or in the cloud. At a high level, energy-level inference engine 260 may receive user energy-level-related information, which may be uploaded from user energy-level logs from client-side applications or services associated with user event monitor 280.

One or more inference algorithms may be applied to the user energy-level-related information to determine a set of energy-level scores. In some aspects, a corresponding confidence for the score is also determined. For example, a user with a lot of data may receive a score with a higher confidence than a user with less data. Additionally, some user data is effectively given more weight than other data when calculating a score. A user having data given more weight may have a higher confidence score. The energy-level pattern may comprise energy levels at different times of the day, week, seasons, and such. For example, an energy-level pattern for a user could comprise a high level of energy in the morning, low level in the afternoon, and medium level in the evening.

As shown in example system 200, energy-level inference engine 260 comprises semantic information analyzer 262, energy-level determiner 264, energy-level pattern determiner 266, escape-activity determiner 268, and energy-level interface component 269. Semantic information analyzer 262 is generally responsible for determining semantic information associated with the energy-level event related features identified by user event monitor 280. For example, while an energy-level event feature may indicate a specific type of exercise (e.g., tennis), the semantic analysis may determine the tennis club the user belongs to, playing partners at the club, upcoming tennis tournaments the user has registered for, or other entities associated with the event. Semantic information analyzer 262 may determine additional event related features semantically related to the event that may be used for identifying user energy-level patterns. For example, the user plays tennis twice as often in the summer and has a higher energy level in the summer. Such an observation could lead to a suggestion to play more tennis (or otherwise exercise more) in the winter.

In particular, as described previously, a semantic analysis is performed on the user energy-level information, which may include contextual information, to characterize aspects of the user actions or energy-level events. For example, energy-level features associated with an event may be categorized (such as by type, time frame or location, work-related, home-related, social, themes, related entities, other user(s) (such as communication to or from another user about an event) and/or relation of the other user to the user (e.g., family member, close friend, work acquaintance, boss, team member, club member, or the like), or other categories), or related features may be identified for use in determining a similarity or relational proximity to other user events, which may indicate a pattern.

In some aspects, semantic information analyzer 262 may utilize a semantic knowledge representation, such as a relational knowledge graph. Semantic information analyzer 262 may also utilize semantic analysis logic, including rules, conditions, or associations to determine semantic information related to the user energy level. For example, a user exercise event comprising playing a sport with someone who works with the user may be characterized as a work-related sports league. Participation in such a league may suggest a positive work environment that contributes to a positive energy level and general satisfaction with work or, at least, work relationships.

Energy-level determiner 264 receives user data and generates an energy-level score. The energy-level determiner 264 can generate energy-level scores periodically, such as hourly or daily. The energy-level score can be generated heuristically or by using machine learning, such as a specially trained machine classifier. The heuristic approach can assign a value to a variable based on user activities and events derived from the user data. For example, receiving seven hours of sleep could result in a 0.8 assigned to the sleep variable, while receiving six hours asleep could result in 0.6 being assigned to the sleep variable. Other event data can be mapped to other variables in a similar fashion. Each variable could be assigned a weight, and then the weight could be combined with the assigned value to determine a score.

A classifier could be trained to receive user input and classify the user into an energy-level category, which is associated with a score. Generally, the classifier can be trained by inputting representative user data into the classifier enforcing the classifier to calculate a specific score. For example, a batch of user data could be input to the classifier and constrained with an energy-level score of seven. A second batch of user data could be input to the classifier and constrained to an energy-level score of five. This process can be repeated until the nodes or features of the classifier are assigned value that result in a similar energy level being calculated when similar data is input. Once trained, the classifier can receive user data and generate a classification in the form of an energy-level score. The energy-level score can be associated with a confidence factor that is also derived from the input. The classifier can receive a large range of values associated with different variables. In some instances, no data will be available for various variables. The difference in the amount of data and type of data as well as the values associated with the data can cause a different confidence score. In some instances, the confidence score can determine how the energy-level inference engine 260 uses individual energy-level scores. For example, scores associated with a low confidence value could be excluded from various calculations, such as a baseline calculation described subsequently.

Energy-level pattern determiner 266 is generally responsible for determining a user energy-level pattern based on individual energy-level scores. In particular, energy-level pattern determiner 266 (or energy-level inference engine 260) may determine a user energy-level pattern based on repetitions of similar energy-level scores associated with the same time stamp. An energy-level pattern comprises a series of representative energy-level scores over time. Each representative score is for a particular point in time. A point in time could be a day of the week, a time of day, and such. Points in time can also be associated with events, such as birthdays, holidays, sporting events, or other dates of significance. For example, a point in time could be a Saturday afternoon on which a user's favorite football team plays. Another point in time could be Saturday afternoon on which the user's favorite football team does not play. In this scenario, a pattern could include a first energy-level score for Saturdays on which the user's favorite football team plays and a second energy-level score for Saturdays in which the user's favorite football team does not play.

A point in time can also be associated with external events, such as weather events. Accordingly, a first point in time could be for a sunny Monday afternoon and a second point in time could be for a cloudy Monday afternoon. In this scenario, the pattern could include a first energy-level score for Monday afternoons that are sunny and a second energy-level score for Monday afternoons that are cloudy.

The representative score can be an average score calculated by averaging all energy-level scores associated with the point in time. In another aspect, the representative score is a mean of all energy-level scores associated with the point in time. Other methods of calculating the representative score are possible.

In some aspects, the output of energy-level pattern determiner 266 may be stored as energy-level patterns 248 in user profile 240 and in some aspects may be provided to an energy-level consumer 270.

Energy-level anomaly determiner 267 detects energy-level score anomalies for a user by first calculating a baseline energy-level score for the user and then detecting deviations from the baseline. In one aspect, an energy-level pattern is used as the baseline score. Individual representative scores within the pattern can form a baseline for an individual point in time. For example, the pattern could show that the user has a representative energy-level score of seven at noon on Mondays. Seven could then be the baseline energy level score for noon on Mondays.

As the energy-level determiner 264 calculates new or current energy-level scores for the user, the current score can be compared against the baseline score. The comparison can be on a point-to-point basis, such as comparing a current score of five calculated for noon on Monday to the baseline score of seven. In order to generate an anomaly, the current score may need to differ from the baseline score by more than a threshold amount. In one aspect, the threshold is a standard deviation.

In another aspect, a pattern of current scores is compared to the baseline pattern. A difference between the patterns may be calculated at each of a series of points and then averaged to determine the existence of an anomaly. Once an anomaly is detected, a notification may be provided to the user, for example, through the energy-level interface component 269.

Escape-activity determiner 268 determines one or more activities that may help the user escape from an anomalous energy-level event. The escape event can be determined for the user by analyzing user data associated with a plurality of people who returned to individual baseline energy-level scores after experiencing an anomalous energy-level event. In order to determine the escape activity, event or behavior patterns for a plurality of users can be generated and correlated with energy-level scores for the plurality of users. The escape activity can be a new activity (from the user's perspective) or an activity engaged in more frequently that occurs contemporaneously with an increased energy level in a user after an anomaly is detected. Contextual information can be used to identify users within the plurality of users that are similarly situated to the individual user experiencing an anomalous energy level. For example, the escape activity for a middle-aged woman working as an executive could be derived by analyzing activity patterns of other middle-aged women working as executives. The escape activity can be a change in a behavior pattern after an anomalous energy level that coincides with an improved energy-level score in the plurality of users.

The escape activity can also be based on an individual user's event pattern. For example, the event pattern may indicate the user is getting less sleep. Getting less sleep can contribute to a lower energy level in the user. In this situation, the energy-level escape activity could be to be in bed by a certain time in order to get an appropriate amount of sleep. However, other activities could be preventing the user from getting enough sleep. For example, perhaps the user has been binge watching a television show as determined from the user data. In this case, the escape activity derived from the actions of others could be an activity that other people not getting enough sleep because of binge watching engaged in to stop binge watching. For example, the escape activity could be reading a book, calling a friend, going out for dinner, or some other activity that effectively distracts the user from binge watching and allows the user to get a healthier amount of sleep.

Energy-level interface component 269 can communicate the existence of an energy-level anomaly to the user along with an escape activity. In addition, the energy-level interface component 269 can provide historic energy-level scores for the user along with recent scores. In one aspect, a line graph of current scores is displayed along with a line graph of the baseline pattern. The energy-level interface component 269 can also solicit feedback about energy level scores. For example, the user can submit an energy level self-evaluation at any given point in time. The self-evaluation can be used to retrain the classifier in a way that is customized for a specific user. The customized classifier can then be used to calculate future energy-level scores. The energy-level interface component 269 can also provide an opt-in and opt-out interface for the user. The opt-in and opt-out interface allows the user to specify what information can be used to calculate the energy-level score, data sources to be accessed, and what information can be shared with others. The interface can ultimately be output through a presentation component 220 or some other component.

Continuing with FIG. 2, example system 200 includes one or more energy-level consumers 270, which comprise applications or services that consume energy-level score information to provide improved user experiences. The energy-level score may be provided to the energy-level consumers 270 through an API. Examples of energy-level consumer 270 may include, without limitation, fitness monitoring and training services, content personalization services, personal assistant applications, and semantic location services, among other services.

In particular, a first example energy-level consumer 270 comprises content personalization services. In one aspect, a content personalization engine 271 is provided to facilitate providing a personalized user experience. Thus, content personalization engine 271 may be considered one example of an application or service (or set of applications or services) that may consume information about user energy-level scores. The content personalization engine 271 may recommend content, such as movies or webpages, based on a user's current energy-level score. The recommendation can be based on past user content consumption at a similar user energy-level score. For example, a user may watch action movies or play first person shooter games when he has a high energy level, but play strategy games when he has a low energy level. Future recommendations could take the current energy-level score into account when making a recommendation.

At a high level, example content personalization engine 271 is responsible for generating and providing aspects of personalized user experiences, such as personalized content or tailored delivery of content to a user. The content may be provided to the user as a personalized notification (such as described in connection to presentation component 220), may be provided to an application or service of the user (such as a calendar or scheduling application), or may be provided as part of an API where it may be consumed by yet another application or service.

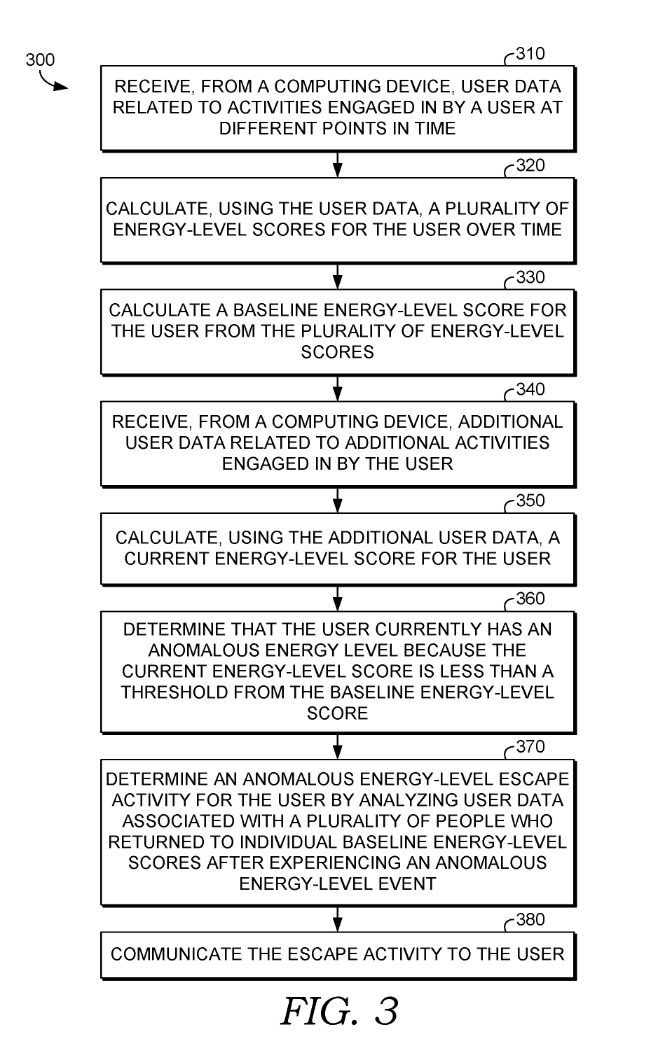

Turning now to FIG. 3, a flow diagram is illustrated showing an exemplary method 300 of detecting an anomaly in a user energy level. Method 300 may be performed by one or more computing devices, such as a smartphone, server, personal computer, or such. The energy level can be inferred through the analysis of user data gathered from multiple computing devices associated with the user.

At step 310, user data related to activities engaged in by a user at different points in time is received from one or more computing devices. The user data can be similar to the user data collected by user-data collection component 210 described previously. Each type of data, for example GPS data, can be received periodically in batches or in real time. For example, a record of a user's daily GPS data could be received from a smartphone. The GPS data could include location data on a minute-by-minute basis or provide location data of particular interest, such as when the user changes locations.

At step 320, a plurality of energy-level scores for the user are calculated using the user data. The plurality of energy-level scores for the user can each be associated with a different time period and be calculated using user data having time stamps within the time period. For example, an energy-level score for a Monday could be calculated using user data collected on the Monday. Some user data that goes into calculating the energy-level score on Monday can be associated with other time periods. In one aspect, a machine classifier is used to generate the energy-level score. The machine classifier can be trained using user data that is associated with an energy level for the user associated with the user data. In one aspect, the user self-reports an energy level, and the self-reported energy level is associated with the user data. Both the energy-level data and the user data can be used to train a classifier. Essentially, the classifier learns that a given input, in the form of user data, should generate a particular energy-level score. Once trained, the machine classifier can generate an energy-level score from an unannotated input of user data.

At step 330, a baseline energy-level score is calculated for the user from the plurality of energy-level scores. The baseline energy-level score can be an average, mean, or some other score derived from the plurality of energy-level scores. In one aspect, the baseline energy-level score can be defined as a range, such as one standard deviation above and below the average energy-level score. A user's baseline energy-level score can be continuously updated as new user data is received and additional energy-level scores are calculated for the user. For example, each time an energy-level score is calculated, the user's baseline energy-level score can be recalculated. In another aspect, the user's baseline energy-level score is recalculated periodically, such as weekly or monthly.

In yet another aspect, a user's baseline energy-level score is calculated based on user data received during a time period when the user reports a normal energy level. For example, an interface can be provided for the user to self-report energy levels during the day. The interface can provide a prompt periodically, such as hourly, for the user to rate their energy level on a scale of 1 to 10. Different people may interpret a scale differently. Accordingly, a first person may provide energy-level reports between five and seven, while a second person provides energy-level reports between two and ten. Accordingly, what constitutes a normal energy-level score can vary from person to person.

At step 340, additional user data related to additional activities engaged in by the user is received. The additional user data is received after the user data used to calculate the baseline energy-level score is received. The user data can be similar to the user data collected by user-data collection component 210 described previously.

At step 350, a current energy-level score for the user is calculated using the additional user data. In one aspect, the additional user data is fed into the machine classifier to generate an energy-level score for the user.

At step 360, the user is determined to currently have an anomalous energy level because the current energy-level score is less than a threshold from the baseline energy-level score. In one aspect, the threshold is a standard deviation from the baseline energy-level score. In one aspect, each newly determined energy-level score can be compared against the baseline energy-level score to determine whether the user's energy-level score is below the threshold.

At step 370, an anomalous energy-level escape activity is determined for the user by analyzing user data associated with a plurality of people who returned to individual baseline energy-level scores after experiencing an anomalous energy-level event. In order to determine the escape activity, event or behavior patterns for a plurality of users can be generated and correlated with energy-level scores for the plurality of users. The escape activity can be a newly detected activity or an activity engaged in more frequently that occurs contemporaneously with an increased energy level in a user after an anomaly is detected. Contextual information can be used to determine users within the plurality of users that are similarly situated to the individual user experiencing an anomalous energy level. For example, the escape activity for a middle-aged woman working as an executive could be derived by analyzing activity patterns of other middle-aged women working as executives.

The escape activity can also be based on an individual user's event pattern. For example, the event pattern may indicate the user is getting less sleep. Getting less sleep can contribute to both a lower energy level in the user and calculating a lower energy-level score. In this situation, the energy-level escape activity could be to be in bed by a certain time in order to get an appropriate amount of sleep. However, other activities could be preventing the user from getting enough sleep. For example, perhaps the user has been binge watching a television show as determined from the user data. In this case, the escape activity derived from the actions of others could be an activity that other people not getting enough sleep because of binge watching engaged in to stop binge watching. For example, the escape activity could be reading a book, calling a friend, going out for dinner, or some other activity that effectively distracts the user from binge watching and allows the user to get a healthier amount of sleep.

At step 380, the escape activity is communicated to the user. The communication can be in the form of a visible notification. In one aspect, the notification is provided by a personal assistant application.

In an aspect, user data can be monitored to determine whether the user follows through with the suggested escape activity. If the user follows through with the suggested escape activity and the user continues to have anomalous energy-level scores, then a second escape activity could be suggested. A second escape activity could also be suggested if the user does not follow through with the originally suggested escape activity.

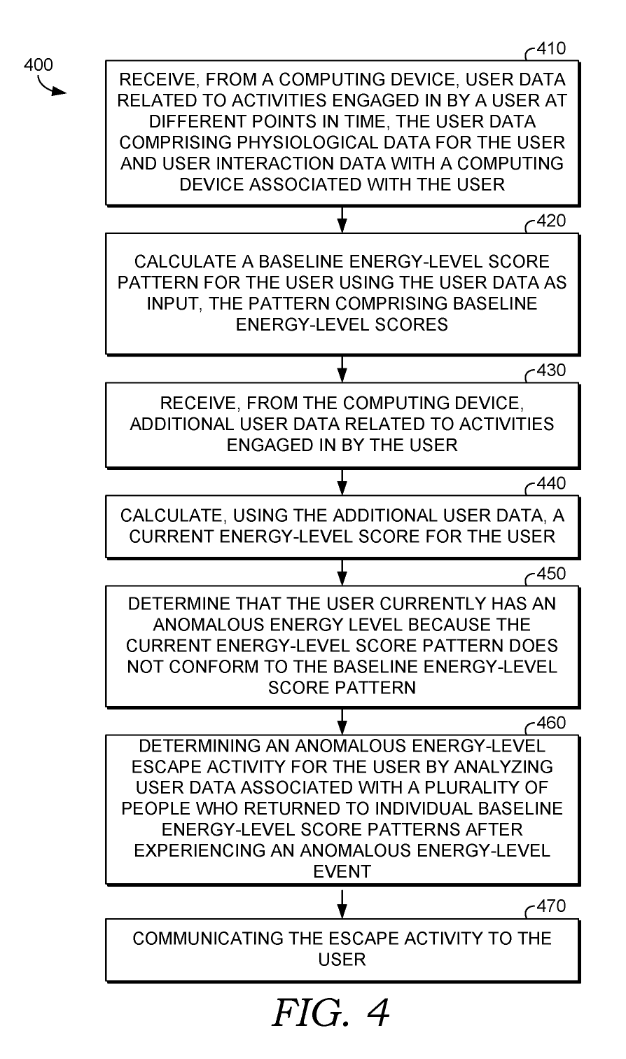

Turning now to FIG. 4, a method 400 of detecting an anomaly in a user energy level is provided. Method 400 may be performed by one or more computing devices, such as a smartphone, server, personal computer, or such. The energy level can be inferred through the analysis of user data gathered from multiple computing devices associated with the user.

At step 410, user data related to activities engaged in by a user at different points in time is received from one or more computing devices associated with the user. The user data comprises physiological data for the user and user interaction data describing interactions with a computing device associated with the user. The user data can be similar to the user data collected by user-data collection component 210 described previously.

At step 420, a baseline energy-level score pattern for the user is calculated using the user data as input. The baseline energy-level score pattern comprises baseline energy-level scores for different periods in time. Each individual energy-level score could be generated by a machine classifier, as described previously. A pattern can comprise energy-level scores over a period of time such as a day, week, month, or such. As is known, a user's energy level can fluctuate throughout the course of a day, week, or month. For example, it may be normal for a user to have a lower energy-level score on Thursday than on Tuesday.

At step 430, additional user data related to activities engaged in by the user is received from one or more computing devices. The additional user data is received after the user data used to calculate the baseline energy-score pattern is received. The user data can be similar to the user data collected by user-data collection component 210 described previously.

At step 440, a current energy-level score for the user is calculated using the additional user data. Additional current energy-level scores can be calculated periodically and used to form a current energy-level pattern. The current pattern could be for the last day, week, or some other amount of time.

At step 450, the user is determined to currently have an anomalous energy level because a current energy-level score pattern does not conform to the baseline energy-level score pattern. Comparing a baseline pattern with a current pattern can reduce the possibility of false positives when determining an anomalous energy level. In one aspect, the patterns can be compared on a point-by-point basis. In an aspect, each point represents a single energy-level score at a point in time. For example, an energy-level score could be calculated for a user each day at midmorning, noon, midafternoon, and evening. If each score in the current energy-level score pattern is below a corresponding score in the baseline energy-level pattern by more than a threshold, an anomalous energy-level event could be determined. In another aspect, an average deviation from the baseline can be calculated to determine that an anomalous energy-level event is occurring when the average difference satisfies a threshold period.

At step 460, an anomalous energy-level escape activity is determined for the user by analyzing user data associated with a plurality of people who returned to individual baseline energy-level score patterns after experiencing an anomalous energy-level event. In order to determine the escape activity, event or behavior patterns for a plurality of users can be generated and correlated with energy-level scores for the plurality of users. The escape activity can be a newly detected activity or an activity engaged in more frequently that occurs contemporaneously with an increased energy level in a user after an anomaly is detected. Contextual information can be used to determine users within the plurality of users that are similarly situated to the individual user experiencing an anomalous energy level. For example, the escape activity for a middle-aged woman working as an executive could be derived by analyzing activity patterns of other middle-aged women working as executives.

The escape activity can also be based on an individual user's event pattern. For example, the event pattern may indicate the user is getting less sleep. Getting less sleep can contribute to both a lower energy level in the user and calculating a lower energy-level score. In this situation, the energy-level escape activity could be to be in bed by a certain time in order to get an appropriate amount of sleep. However, other activities could be preventing the user from getting enough sleep. For example, perhaps the user has been binge watching a television show as determined from the user data. In this case, the escape activity derived from the actions of others could be an activity that other people not getting enough sleep because of binge watching engaged in to stop binge watching. For example, the escape activity could be reading a book, calling a friend, going out for dinner, or some other activity that effectively distracts the user from binge watching and allows the user to get a healthier amount of sleep.

At step 470, the escape activity is communicated to the user. The communication can be in the form of a visible notification. In one aspect, the notification is provided by a personal assistant application.

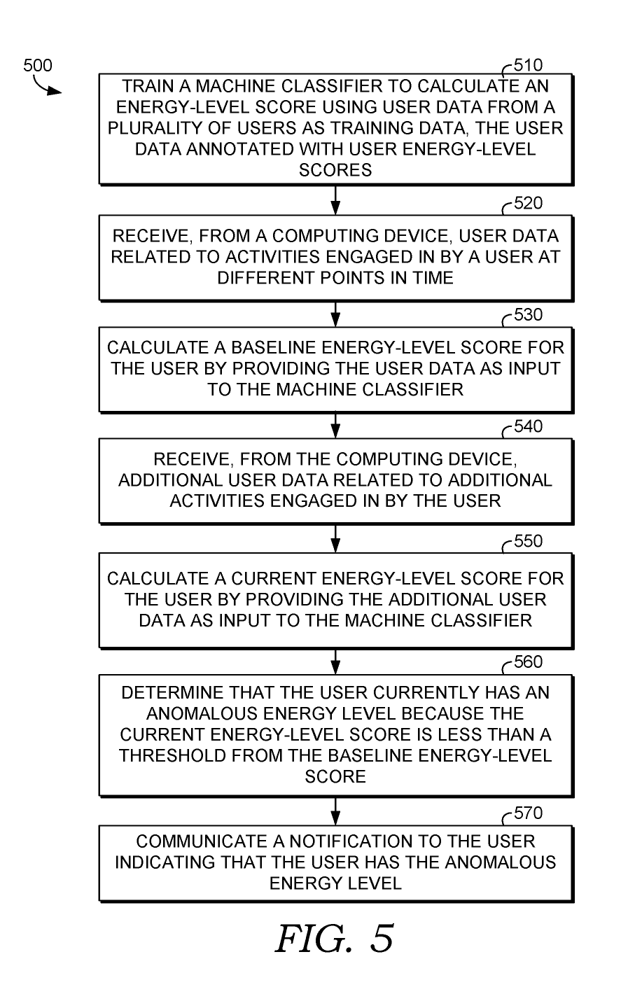

Turing now to FIG. 5, a method 500 of detecting an anomaly in a user energy level is provided. Method 500 may be performed by one or more computing devices, such as a smartphone, server, personal computer, or such. The energy level can be inferred through the analysis of user data gathered from multiple computing devices associated with the user.

At step 510, a machine classifier is trained to calculate an energy-level score using user data from a plurality of users. The user data is annotated with user energy-level scores. The machine classifier can be trained using user data that is associated with an energy level for the user associated with the user data. In one aspect, the user self-reports an energy level, and the self-reported energy level is associated with the user data. Both the energy level data and the user data can be used to train a classifier. Essentially, the classifier learns that a given input, in the form of user data, should generate a particular energy-level score. Once trained, the machine classifier can generate an energy-level score from an unannotated input of user data.

In another aspect, the training data is artificially generated and annotated to train the classifier. In other words, real or artificially generated user data deemed to indicate healthy behaviors could be associated with a high energy level, and user data deemed to indicate unhealthy behavior could be associated with a low energy level. The artificially generated user data could then be used to train a classifier.

At step 520, user data related to activities engaged in by a user at different points in time is received from one or more computing devices. The user data can be similar to the user data collected by user-data collection component 210 described previously.

At step 530, a baseline energy-level score is calculated for the user by providing the user data as input to the machine classifier. The baseline energy-level score can be an average, mean, or some other score derived from the plurality of energy-level scores. In one aspect, the baseline energy-level score can be defined as a range, such as one standard deviation above and below the average energy-level score. A user's baseline energy-level score can be continuously updated as new user data is received and additional energy-level scores are calculated for the user. For example, each time an energy-level score is calculated, the user's baseline energy-level score can be recalculated. In another aspect, the user's baseline energy-level score is recalculated periodically, such as weekly or monthly.

At step 540, additional user data related to activities engaged in by the user is received from the one or more computing devices. The additional user data is received after the user data used to calculate the baseline energy-level score is received. The user data can be similar to the user data collected by user-data collection component 210 described previously.

At step 550, a current energy-level score is calculated for the user by providing the additional user data as input to the machine classifier.

At step 560, the user is determined to currently have an anomalous energy level because the current energy-level score is less than a threshold from the baseline energy-level score. In one aspect, the threshold is a standard deviation from the baseline energy-level score. In one aspect, each newly determined energy-level score can be compared against the baseline energy-level score to determine whether the user's energy-level score is below the threshold.

At step 570, a notification is communicated to the user indicating that the user has the anomalous energy level. The communication can be in the form of a visible notification. In one aspect, the notification is provided by a personal assistant application. The notification can also be part of an energy-level interface. The personal assistant application or an energy-level specific application can provide a user interface through which both a baseline energy level and current energy-level scores are provided. The interface can allow the user to provide feedback, including subjectively reporting a current energy level. The subjective reporting can be used as a feedback loop to customize the machine classifier to the individual user. In other words, the subjective reporting data can be used to retrain the classifier. Once retrained, the classifier can be used to calculate additional energy-level scores and to recalculate previously calculated energy-level scores where the raw data is still available. The recalculated energy-level scores can be used to calculate a new baseline for the user.

### Exemplary Operating Environment

Referring to the drawings in general, and initially to FIG. 6 in particular, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, optical-disc drives, etc. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, vibrating component, etc. I/O ports 618 allow computing device 600 to be logically coupled to other devices, including I/O components 620, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include a radio 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

### EMBODIMENTS

### Embodiment 1

A computing system comprising: a processor; computer storage memory having computer-executable instructions stored thereon which, when executed by the processor, configure the processor to: receive, from a computing device, user data related to activities engaged in by a user at different points in time; calculate, using the user data, a plurality of energy-level scores for the user over time; calculate a baseline energy-level score for the user from the plurality of energy-level scores; receive, from a computing device, additional user data related to additional activities engaged in by the user; calculate, using the additional user data, a current energy-level score for the user; determine that the user currently has an anomalous energy level because the current energy-level score is less than a threshold from the baseline energy-level score; determine an anomalous energy-level escape activity for the user by analyzing user data associated with a plurality of people who returned to individual baseline energy-level scores after experiencing an anomalous energy-level event; and communicate the escape activity to the user.

### Embodiment 2

The system of Embodiment 1, wherein the user data comprises sleep data for the user gathered by a wearable computing device and user interaction data with a computing device associated with the user.

### Embodiment 3

The system of Embodiment 2, wherein the computing system is further configured to generate: a typical duration of time between a last user interactivity with the computing device and sleep initiation (hereafter “device-to-sleep duration”), as determined from the user interaction data, and the user falling asleep, as determined from the sleep data; a typical duration of time between sleep termination and a first user interactivity with the computing device (hereafter “sleep-to-device duration”), as determined from the user interaction data, and the user waking from sleep, as determined from the sleep data; and a duration for a sleep event for the user that occurs when the sleep data does not include readings during the sleep event by using the user interaction data and the sleep-to-device duration and the device-to-sleep duration.

### Embodiment 4

The system of any one of the above embodiments 1, wherein the current energy-level score is based on a task completion productivity measured by the user data, wherein the user data comprises activity data describing actions taken by a user through one or more computing devices.

### Embodiment 5

The system of any one of the above embodiments 1, wherein the energy-level score is based on a frequency and duration of social events in which the user participates, the occurrence of a social event determined from the user data.

### Embodiment 6

The system of any one of the above embodiments 1, wherein a personal assistant application communicates the escape activity to the user.

### Embodiment 7

The system of any one of the above embodiments 1, wherein the baseline energy-level score is for a time of day and a day of the week and the current energy-level score is for the time of day and the day of the week.

### Embodiment 8

A method of detecting an anomaly in a user energy level, the method comprising: receiving, from a computing device, user data related to activities engaged in by a user at different points in time, the user data comprising physiological data for the user and user interaction data describing interactions with a computing device associated with the user; calculating a baseline energy-level score pattern for the user using the user data as input, the baseline energy-level score pattern comprising baseline energy-level scores for different periods in time; receiving, from a computing device, additional user data related to activities engaged in by the user; calculating, using the additional user data, a current energy-level score for the user; determining that the user currently has an anomalous energy level because a current energy-level score pattern does not conform to the baseline energy-level score pattern; determining an anomalous energy-level escape activity for the user by analyzing user data associated with a plurality of people who returned to individual baseline energy-level score patterns after experiencing an anomalous energy-level event; and communicating the escape activity to the user.

### Embodiment 9

The method of embodiment 8, wherein individual energy-level scores are calculated using a machine classifier.

### Embodiment 10

The method of embodiment 9, wherein the user data comprises browsing history data.

### Embodiment 11

The method of any one of embodiments 8, 9, or 10, wherein the user data comprises social event data.

### Embodiment 12

The method of any one of embodiments 8, 9, 10, or 11, wherein the baseline energy-level score pattern is for a day of the week and the current energy-level score is for the same day of the week.

### Embodiment 13

The method of any one of embodiments 8, 9, 10, 11, or 12, wherein the method further comprises continuing to monitor energy-level scores of the user and determining that the escape activity was not performed by the user and communicating a second escape activity to the user.

### Embodiment 14

The method any one of embodiments 8, 9, 10, 12, 13, or 14, wherein the user data comprises a sleep data for the user gathered by a wearable computing device and a user interaction data with a computing device associated with the user and wherein the method further comprises: determining a typical duration of time between a last user interactivity with the computing device and sleep initiation (hereafter “device-to-sleep duration”), as determined from the user interaction data, and the user falling asleep, as determined from the sleep data; determining a typical duration of time between sleep termination and a first user interactivity with the computing device (hereafter “sleep-to-device duration”), as determined from the user interaction data, and the user waking from sleep, as determined from the sleep data; and determining a duration for a sleep event for the user that occurs when the sleep data does not include readings during the sleep event by using the user interaction data and the sleep-to-device duration and the device-to-sleep duration.

### Embodiment 15

The any one of embodiments 8, 9, 10, 11, 12, 13, 14 or 15, wherein a personal assistant application communicates the escape activity to the user.

### Embodiment 16

A method of inferring a user energy level comprising: training a machine classifier to calculate an energy-level score using user data from a plurality of users as training data, the user data annotated with user energy-level scores; receiving, from a computing device, user data related to activities engaged in by a user at different points in time; calculating a baseline energy-level score for the user by providing the user data as input to the machine classifier; receiving, from the computing device, additional user data related to activities engaged in by the user; calculating a current energy-level score for the user by providing the additional user data as input to the machine classifier; determining that the user currently has an anomalous energy level because the current energy-level score is a threshold from the baseline energy-level score; and communicating a notification to the user indicating that the user has the anomalous energy level.

### Embodiment 17

The method of embodiment 16, further comprising generating the user data annotated with energy-level scores by asking users to self-report periodic energy levels and associating the self-reported energy levels with user data gathered contemporaneously with the self-reported energy levels.

### Embodiment 18

The method of any one of embodiments 16 or 17, wherein the baseline energy-level score is for a day of the week and the current energy-level score is for the day of the week.

### Embodiment 19

The method of any one of embodiments 16, 17, or 18, further comprising determining an anomalous energy-level escape activity for the user by analyzing user data associated with a plurality of people who returned to individual baseline energy-level score patterns after experiencing an anomalous energy-level event.

### Embodiment 20

The method any one of embodiments 16, 17, 18, or 19, further comprising determining an anomalous energy-level escape activity for the user by analyzing actions taken by the user previously that returned the user to the baseline energy-level score after experiencing an anomalous energy-level event and communicating the escape activity to the user.

### Embodiment 21

The method of any one of the above embodiments, wherein a personal assistant application identifies user behavior patterns and communicates the user behavior patterns to the user.

### Embodiment 22

The method of any one of the above embodiments, further comprising identifying user behavior anomalies.

### Embodiment 23

The method of any one of the above embodiments wherein a behavior pattern is detected using combined signals as input, wherein the combined signals are selected from the group consisting of sleep, travel, time spent at places, browsing behavior, time on social media, and phone usage.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A computing system comprising:
a processor;
computer storage memory having computer-executable instructions stored thereon which, when executed by the processor, configure the processor to:
receive, from a computing device, user data related to activities engaged in by a user at different points in time;
calculate, using the user data, a plurality of energy-level scores for the user over time;
calculate a baseline energy-level score for the user from the plurality of energy-level scores;
receive, from a computing device, additional user data related to additional activities engaged in by the user;
calculate, using the additional user data, a current energy-level score for the user;
determine that the user currently has an anomalous energy level because the current energy-level score is less than a threshold from the baseline energy-level score;
determine an anomalous energy-level escape activity for the user by analyzing user data associated with a plurality of people who returned to individual baseline energy-level scores after experiencing an anomalous energy-level event; and
communicate the escape activity to the user.

2. The system of claim 1, wherein the user data comprises sleep data for the user gathered by a wearable computing device and user interaction data with a computing device associated with the user.

3. The system of claim 2, wherein the computing system is further configured to generate:
a typical duration of time between a last user interactivity with the computing device and sleep initiation (hereafter “device-to-sleep duration”), as determined from the user interaction data, and the user falling asleep, as determined from the sleep data;
a typical duration of time between sleep termination and a first user interactivity with the computing device (hereafter “sleep-to-device duration”), as determined from the user interaction data, and the user waking from sleep, as determined from the sleep data; and
a duration for a sleep event for the user that occurs when the sleep data does not include readings during the sleep event by using the user interaction data and the sleep-to-device duration and the device-to-sleep duration.

4. The system of claim 1, wherein the current energy-level score is based on a task completion productivity measured by the user data, wherein the user data comprises activity data describing actions taken by a user through one or more computing devices.

5. The system of claim 1, wherein the energy-level score is based on a frequency and duration of social events in which the user participates, the occurrence of a social event determined from the user data.

6. The system of claim 1, wherein a personal assistant application communicates the escape activity to the user.

7. The system of claim 1, wherein the baseline energy-level score is for a time of day and a day of the week and the current energy-level score is for the time of day and the day of the week.

8. A method of detecting an anomaly in a user energy level, the method comprising:
receiving, from a computing device, user data related to activities engaged in by a user at different points in time, the user data comprising physiological data for the user and user interaction data describing interactions with a computing device associated with the user;
calculating a baseline energy-level score pattern for the user using the user data as input, the baseline energy-level score pattern comprising baseline energy-level scores for different periods in time;
receiving, from a computing device, additional user data related to activities engaged in by the user;
calculating, using the additional user data, a current energy-level score for the user;
determining that the user currently has an anomalous energy level because a current energy-level score pattern does not conform to the baseline energy-level score pattern;
determining an anomalous energy-level escape activity for the user by analyzing user data associated with a plurality of people who returned to individual baseline energy-level score patterns after experiencing an anomalous energy-level event; and
communicating the escape activity to the user.

9. The method of claim 8, wherein individual energy-level scores are calculated using a machine classifier.

10. The method of claim 9, wherein the user data comprises browsing history data.

11. The method of claim 8, wherein the user data comprises social event data.

12. The method of claim 8, wherein the baseline energy-level score pattern is for a day of the week and the current energy-level score is for the same day of the week.

13. The method of claim 8, wherein the method further comprises continuing to monitor energy-level scores of the user and determining that the escape activity was not performed by the user and communicating a second escape activity to the user.

14. The method of claim 8, wherein the user data comprises a sleep data for the user gathered by a wearable computing device and a user interaction data with a computing device associated with the user and wherein the method further comprises:
determining a typical duration of time between a last user interactivity with the computing device and sleep initiation (hereafter “device-to-sleep duration”), as determined from the user interaction data, and the user falling asleep, as determined from the sleep data;
determining a typical duration of time between sleep termination and a first user interactivity with the computing device (hereafter “sleep-to-device duration”), as determined from the user interaction data, and the user waking from sleep, as determined from the sleep data; and
determining a duration for a sleep event for the user that occurs when the sleep data does not include readings during the sleep event by using the user interaction data and the sleep-to-device duration and the device-to-sleep duration.

15. The method of claim 8, wherein a personal assistant application communicates the escape activity to the user.

16. A method of inferring a user energy level comprising:
training a machine classifier to calculate an energy-level score using user data from a plurality of users as training data, the user data annotated with user energy-level scores;
receiving, from a computing device, user data related to activities engaged in by a user at different points in time;
calculating a baseline energy-level score for the user by providing the user data as input to the machine classifier;
receiving, from the computing device, additional user data related to activities engaged in by the user;
calculating a current energy-level score for the user by providing the additional user data as input to the machine classifier;
determining that the user currently has an anomalous energy level because the current energy-level score is a threshold from the baseline energy-level score; and
communicating a notification to the user indicating that the user has the anomalous energy level.

17. The method of claim 16, further comprising generating the user data annotated with energy-level scores by asking users to self-report periodic energy levels and associating the self-reported energy levels with user data gathered contemporaneously with the self-reported energy levels.

18. The method of claim 16, wherein the baseline energy-level score is for a day of the week and the current energy-level score is for the day of the week.

19. The method of claim 16, further comprising determining an anomalous energy-level escape activity for the user by analyzing user data associated with a plurality of people who returned to individual baseline energy-level score patterns after experiencing an anomalous energy-level event.

20. The method of claim 16, further comprising determining an anomalous energy-level escape activity for the user by analyzing actions taken by the user previously that returned the user to the baseline energy-level score after experiencing an anomalous energy-level event and communicating the escape activity to the user.
